(19) United States
(12) Patent Application Publication
(10) Pub. No.: US 2001/0051914 A1
(43) Pub. Date: Dec. 13, 2001

(54) Loan system of financial institution and method thereof

(75) Inventors: Dong-Kyoon Yoon, Seoul (KR); Hak-Sung Kim, Kyungki-do (KR)

Correspondence Address: ROTHWELL, FIGG, ERNST & MANBECK, P.C., 555 13TH STREET, N.W., SUITE 701, EAST TOWER, WASHINGTON, DC, 20004, US

(73) Assignee: NONGSHIM CO., LTD

(21) Appl. No.: 09/874,224

(22) Filed: Jun. 6, 2001

(30) Foreign Application Priority Data
Jun. 7, 2000 (KR) 2000-31025

(51) Int. Cl. G06F 17/60

(52) U.S. Cl. 705/38

(57) ABSTRACT

A loan system of a financial institution for processing loans for repayment of credit accounts of multiple agents who have purchased products on credit based on collateral offered to a supplier, including an account opening unit for receiving information required for opening an ordinary account and a loan account of each agent and an ordinary account of the supplier, and opening accounts corresponding the information, a collateral information receiver unit for receiving information on the appraised value for each agent's collateral offered to the supplier, from a supplier's collecting system, an ordinary account transfer unit for transferring money from the ordinary account of each agent to the supplier's ordinary account according to money transfer information transferred from agent terminals, and a loan account transfer unit for transferring loans, each loan processed within the limit of a corresponding agent's collateral only to the supplier's ordinary account according to the loan request information transferred from a corresponding agent terminal.

### BACKGROUND OF THE INVENTION

1. Field of the Invention

The present invention relates to a loan system of a financial institution, and more particularly, to a loan system with transaction security in the form of collateral that is offered by clients (agents) to a supplier of products and shared by the supplier and the financial institution.

2. Description of the Related Art

In general, a supplier receives collateral from an agent that sells the supplier's products, and supplies the selling agent with products on credit within the limit of the collateral. The agent sells the products supplied on credit, collects the money from sales and then repays the credit accounts. In the event the money from sales for the products supplied on credit is not collected by the appointed date, the deficit should be made up by separately raised funds or loans from a financial institution.

In order for an agent to borrow money from a financial institution, the agent must provide the financial institution with collateral, separately from the collateral given to the supplier. In actuality, it is usually quite difficult for the agent to provide additional collateral. Also, in the event the agent cannot pay the supplied product price by the appointed date, the supplier may have difficulty of a turnover of funds.

### SUMMARY OF THE INVENTION

To solve the above problems, it is an objective of the present invention to provide a loan system of a financial institution, for loaning agents money to pay back a supplier, without need for the agents to provide separate collateral other than collateral offered to the supplier, and a method thereof.

It is another objective of the present invention to provide a loan system of a financial institution for ensuring transaction security on a payment guarantee of a supplier based on collateral offered to the supplier by agents, and a method thereof.

Accordingly, to achieve the first objective, there is provided a loan system of a financial institution for processing loans for repayment of credit accounts of multiple agents who have purchased products on credit based on collateral offered to a supplier, including an account opening unit for receiving information required for opening an ordinary account and a loan account of each agent and an ordinary account of the supplier, and opening accounts corresponding the information, a collateral information receiver unit for receiving information on the appraised value for each agent's collateral offered to the supplier, from a supplier's collecting system, an ordinary account transfer unit for transferring money from the ordinary account of each agent to the supplier's ordinary account according to money transfer information transferred from agent terminals, and a loan account transfer unit for transferring loans, each loan processed within the limit of a corresponding agent's collateral only to the supplier's ordinary account according to the loan request information transferred from a corresponding agent terminal.

To achieve the second objective, there is provided a financial institution's loan method for processing loans for repayment of credit accounts of multiple agents who have purchased products on credit based on collateral offered to a supplier, including the steps of (a) receiving information required for opening an ordinary account and a loan account of each agent and an ordinary account of the supplier, and opening accounts corresponding the information, (b) receiving information on the appraised value for the agent's collateral offered to the supplier, from a supplier, (c) transferring money from the ordinary account of each agent to the supplier's ordinary account according to money transfer information from agent terminals, and (d) transferring loans processed within the limit of a corresponding agent's collateral only to the supplier's ordinary account according to the loan request information transferred from a corresponding agent terminal, if the credit accounts are not fully repaid in step (c).

### BRIEF DESCRIPTION OF THE DRAWINGS

The above objectives and advantages of the present invention will become more apparent by describing in detail a preferred embodiment thereof with reference to the attached drawings in which:

FIG. 1 is a block diagram of the component devices of a loan system of a financial institution according to an embodiment of the present invention;

FIG. 2 is an overview flowchart of the process of a financial institution's loan method according to the present invention; and

FIG. 3 is a block diagram of the component devices of a loan system of a financial institution according to another embodiment of the present invention.

### DESCRIPTION OF THE PREFERRED EMBODIMENTS

The present invention will now be described in detail with reference to the accompanying drawings.

The term “supplier” throughout the description set forth herein, is used in a broader concept to encompass both a manufacturer and a distributor of products. Herein, the term “agent” is intended to encompass all types of customers who are provided with products from the supplier as well as distributors who have established an agent contract with the supplier.

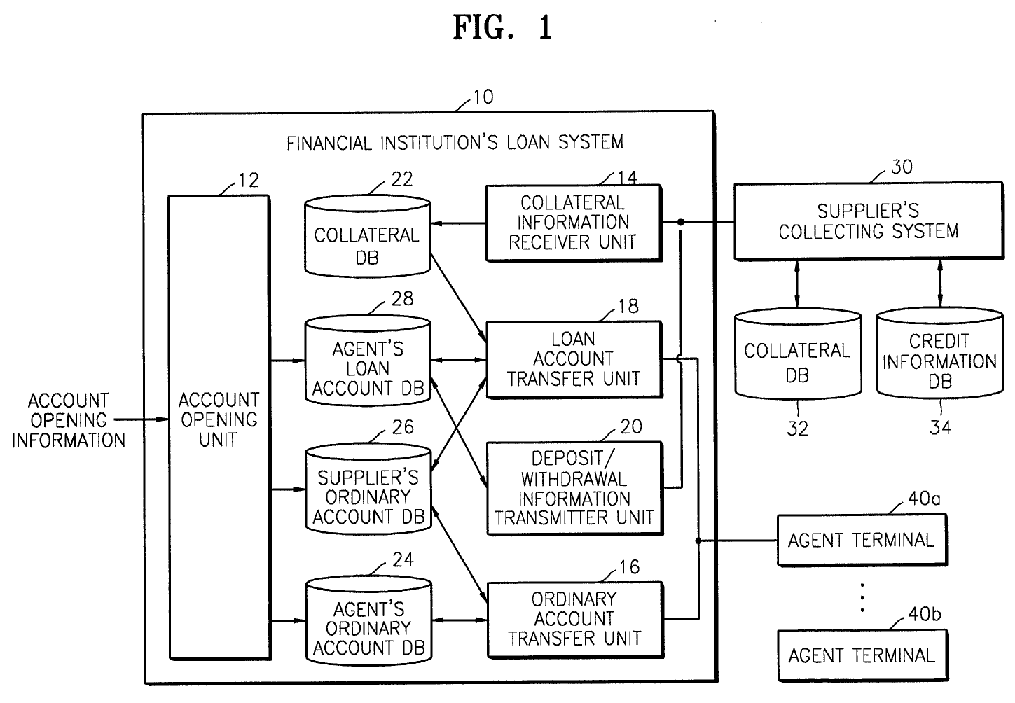

Referring to FIG. 1, a financial institution's loan system 10 according to an embodiment of the present invention is connected with a specified supplier's collecting system 30 via a network such as the Internet, or leased line, to transmit/receive information. The product supplier's collecting system 30 processes a collection of credit accounts receivable.

Also, the financial institution's loan system 10 is connected with one or more agent terminals 40a to 40b via a network such as the Internet, or leased line, to transmit/receive information. The agent terminals 40a to 40b are used when multiple agents who are provided with products on credit based on their collateral offered to the supplier request their correspondent banks for loan processing.

The financial institution's loan system 10 includes an account opening unit 12, a collateral information receiver unit 14, an ordinary account transfer unit 16, a loan account transfer unit 18 and a deposit/withdrawal information transmitter unit 20.

The account opening unit 12 receives information required for opening an ordinary account of each agent, a loan account of each agent and an ordinary account of each supplier, and opens accounts corresponding to the received information in a database 24 for the ordinary account of each agent (termed “agent's ordinary account DB”), a database 28 for the loan account of each agent (termed “agent's loan account DB”), and a database 26 for the supplier's ordinary account (termed “supplier's ordinary account DB”). In the case of the agent's and supplier's ordinary accounts, deposits and withdrawals can be freely made. In the case of the agent's loan account, the withdrawal transfer to the supplier's ordinary account is the only withdrawal allowed whereas deposits can be freely made.

The collateral information receiver unit 14 receives an appraised value of collateral offered to the supplier by the respective agents from the supplier's collecting system 30 and stores the same in a collateral DB 22.

The agent's ordinary account DB 24, the agent's loan account DB 28, and the supplier's ordinary account DB 26, are systematically stored on a recording medium such as a hard disk, so as to easily add, renew and refer to related data. Herein, the term “database” is intended to encompass a recording medium and data stored thereon. Although it has been described in an embodiment of the present invention that the respective databases are separately stored on different recording media, the databases may be stored on the same recording medium by a separate management system, without departing from the scope of the present invention.

The ordinary account transfer unit 16 transfers money from the ordinary accounts of the respective agents to the supplier's ordinary account according to money transfer information from the agent terminals 40a to 40b. Here, what is meant by ‘ordinary account transfer’ is not necessarily a transfer to the supplier's ordinary account; a transfer from the agent's ordinary account to an account other than the supplier's ordinary account is also allowed.

The loan account transfer unit 18 transfers the loan processed within the limit of collateral of the corresponding agent only to the supplier's ordinary account according to the loan request information transferred from the appropriate agent terminal among the agent terminals 40a or 40b.

The deposit/withdrawal information transmitter unit 20 transmits deposit/withdrawal information to the supplier's collecting system 30 in real-time whenever money is deposited into/withdrawn from the agent's loan account.

The supplier's collecting system 30 stores an appraised value of collateral offered by each agent in each collateral DB 32 for management, and transmits information on a newly established agent or an agent that has changed collateral, to the financial institution's loan system 10.

Also, the supplier's collecting system 30 stores credit information, including credit accounts receivable for the total amount of products supplied to each agent on credit, and loan balance included in the deposit/withdrawal information transmitted from the financial institution's loan system 10, in a credit information DB 34 for management.

Thus, when the supplier supplies each agent with products on credit, the supplier makes additional credit sales within the limit of the amount calculated by deducting the sum of a current credit accounts receivable and a remaining portion of the loan from the agent's collateral.

The agent terminals 40a to 40b connected to the financial institution's loan system 10 can inquire each agent's account, and transmit money transfer information or loan request information on each agent to the financial institution's loan system 10.

Each of the agent terminals 40a to 40b may be a personal computer connected to the financial institution's loan system 10 via a leased line, or a mobile terminal such as a personal digital assistant (PDA) wirelessly connected to a mobile communication operator's system connected to the financial institution's loan system 10 via a leased line.

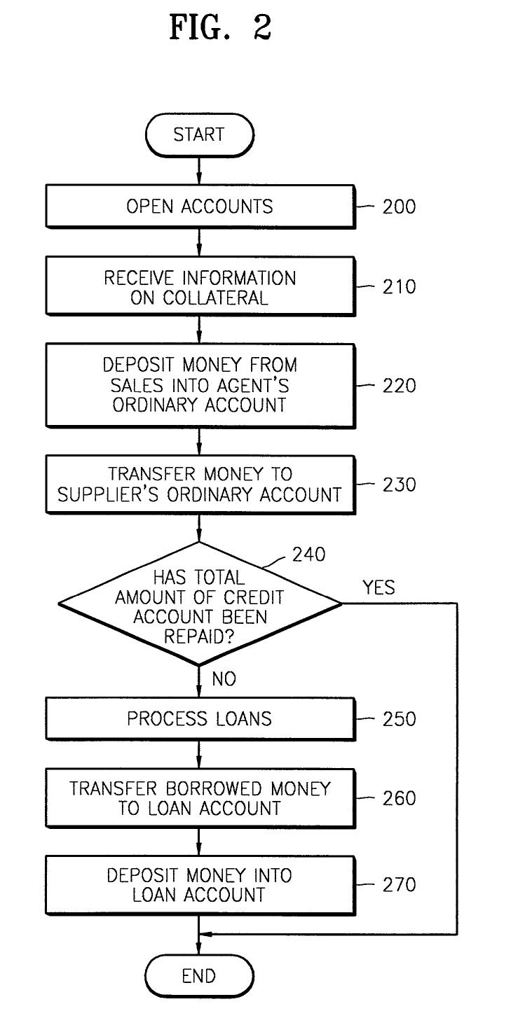

The operation of the loan system according to an embodiment of the present invention shown in FIG. 1 will now be described with reference to FIG. 2.

First, in order for an agent to transact with a supplier on credit, the agent must offer collateral to the supplier. In the present invention, the term “collateral” is intended to encompass both actual security such as real estate, securities, cash or guarantee insurance and agent's credit given (approved) by the supplier.

The supplier evaluates the collateral or credit of the agent, stores the same in a collateral DB 32 of the supplier's collecting system 30 for management. Then, at a financial institution associated with the supplier, the agent opens an ordinary account into which deposits and from which withdrawals can be freely made, and a loan account into which deposits can be freely made and withdrawals are limited to a transfer to the supplier's ordinary account (step 200). Here, the loan approved by the financial institution for each agent is under the payment guarantee of the supplier based on the collateral offered to the supplier by the agent.

Then, the financial institution's loan system 10 receives information on the collateral for a newly established agent or an agent that has changed collateral from the supplier's collecting system 30 (step 210).

The agent sells the products supplied by the supplier, collects the money from sales and deposits the collected money into the agent's ordinary account opened with the financial institution (step 220).

The agent repays the credit accounts payable to the supplier by maturity. To this end, the agent inquires as to the balance of its own ordinary account. If there are funds in its own ordinary account, the agent generates money transfer information necessary to transfer the money to the supplier's ordinary account, and transmits the information to the financial institution's loan system 10. The ordinary account transfer unit 16 of the financial institution's loan system 10 receives the money transfer information, withdraws money from the agent's ordinary account and transfers the money to the supplier's ordinary account, thereby processing repayment for the credit accounts (step 230).

Next, it is determined whether the credits accounts have been repaid in full (step 240).

In this case, if the balance of the agent's ordinary account is greater than the credit accounts to be repaid, the repayment for the credit accounts can be completed. Otherwise, the agent makes up the deficit with a loan from the financial institution for repayment. In other words, if the total amount of the credit accounts are not repaid, the agent inquires as to balance of its own account opened with the financial institution, generates loan transfer information necessary to generate a loan corresponding to the remaining credit accounts that have not been repaid, within the limit of a remaining portion of the loan, and to transfer the borrowed money to the supplier's ordinary account, and transfers the generated information to the financial institution's loan system 10 (step 250).

The loan account transfer unit 16 of the financial institution's loan system 10 receives the loan transfer information, processes loan within the limit of the agent's collateral and transfers the borrowed money to the supplier's ordinary account, thereby processing repayment for the outstanding balance of credit accounts (step 260). In this case, the deposit/withdrawal information transmitter unit 20 of the financial institution's loan system 10 transmits information on a remaining portion of the loan available from the agent's loan account to the supplier's collecting system 30 in real-time, to be referred to when the agent makes an additional purchase on credit.

In the event that the agent acquires idle money or collects money from sales of the products supplied by the supplier, the agent deposits the money into its own loan account with the financial institution for repayment of the loan (step 270). Here, the deposit/withdrawal information transmitter unit 20 of the financial institution's loan system 10 also transmits the information on a remaining portion of the loan available from the agent's loan account to the supplier's collecting system 30 in real-time, to be referred to when the agent makes an additional purchase on credit.

If the financial institution's loan cannot be redeemed by the agent, the financial institution imposes the outstanding loan on the supplier. Then, the supplier repays the outstanding loan through disposition of the agent's collateral.

In the case where credit transaction is made between the supplier and the agent without collateral given to the supplier, if the agent cannot repay the loan to the financial institution, the supplier that approved the agent's credit must assume the responsibility of repaying the agent's outstanding loan to the financial institution in place of the agent.

Also, in the case where the collateral given to the supplier is not cash, the supplier's credit sales for the agent are managed in the form of deposit received, without being canceled until the agent repays the loan to the financial institution, even when the financial institution's loan is transferred to the supplier's ordinary account.

Since collateral other than cash, based on the credit sales, is valid until the agent repays the financial institution's loan, the supplier can repay the loan with the collateral if the agent cannot redeem the loan.

If the agent repays the loan to the financial institution afterward, the supplier's deposit received, corresponding to the repaid amount, is offset by the credit account payable.

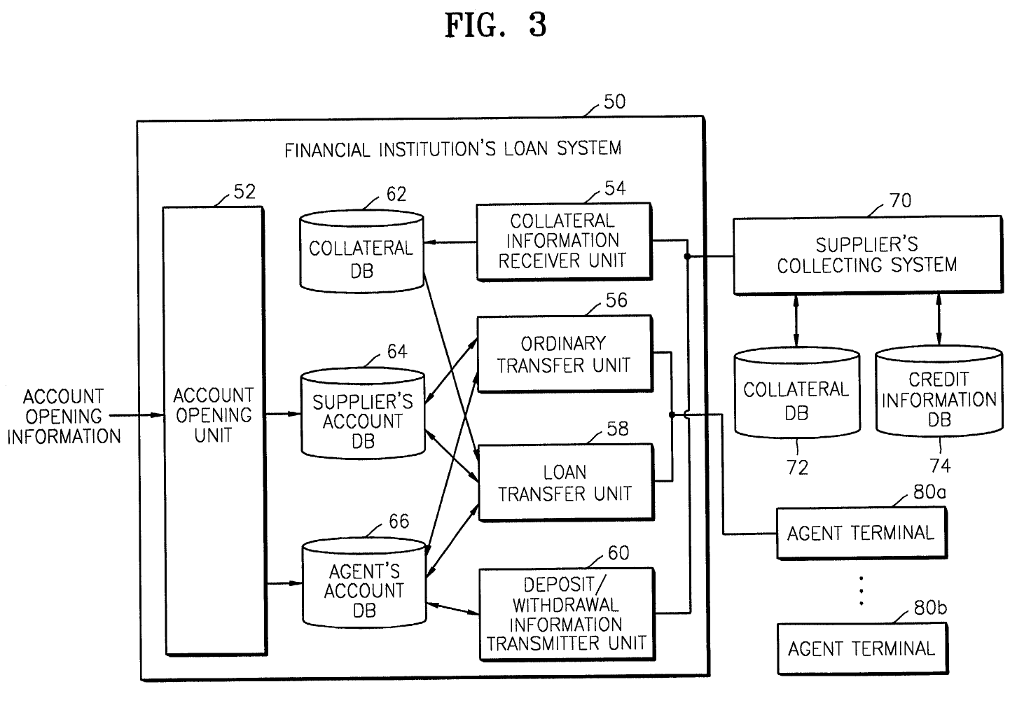

Referring to FIG. 3, a financial institution's loan system 50 according to another embodiment of the present invention is connected to a supplier's collecting system 70 of a particular supplier, for collecting money based on credit sales, via a network such as the Internet, or a leased line, and transmits/receives information. Also, the financial institution's loan system 50 is connected to agent terminals 80a to 80b by which multiple agents for conducting a credit purchase based on collateral request a financial institution for loan processing, via a network such as the Internet, or a leased line, and transmits/receives information. The financial institution's loan system 50 includes an account opening unit 52, a collateral information receiver unit 54, an ordinary transfer unit 56, a loan transfer unit 58 and a deposit/withdrawal information transfer unit 60.

The account opening unit 52 receives information required for opening an account of each agent and an account of each supplier, and opens accounts at the financial institution corresponding to the received information, and keeping record of the accounts in a database 66 for the agent's account (termed “agent's account DB”) and a database 64 for the supplier's account (termed “supplier's account DB”). Unlike the embodiment shown in FIG. 1 in which the agent's ordinary account and the agent's loan account are separately opened, in the embodiment shown in FIG. 3, deposit/withdrawal of money and loaning are processed by one and the same account. However, in the agent's account, deposit/withdrawal and loaning are separately managed. In other words, while deposits of money into the agent's account can be freely made, withdrawals of borrowed money from the agent's account are restricted to transfers into the supplier's account only.

The collateral information receiver unit 54 receives information on agent's collateral from the supplier's collecting system 70 and stores the same in a collateral DB 62.

The agent's account DB 66, the supplier's account DB 64 and the collateral DB 62, are systematically stored on a recording medium such as a hard disk, so as to easily add, renew and refer to related data. Herein, the term “database” is intended to encompass a recording medium and data stored thereon. Although it has been described in an embodiment of the present invention that the respective databases are separately stored on different recording media, the databases may be stored on the same recording medium by a separate management system, without departing from the scope of the present invention.

The ordinary transfer unit 56 transfers money to the supplier's account according to money transfer information from the agent terminals 80a to 80b. Here, what is meant by ‘ordinary transfer’ is not necessarily a transfer to the supplier's account; a transfer from the agent's account to an account other than the supplier's account is also allowed.

The loan transfer unit 58 transfers the loan processed within the limit of collateral of the corresponding agent only to the supplier's account according to the loan request information transferred from the appropriate agent terminal among the agent terminals 80a to 80b. Since the term ‘loan transfer’ means only a transfer to the supplier's account, the transfer or deposit of the loan approved for the agent's account to an account other than the supplier's account is not allowed.

The deposit/withdrawal information transmitter unit 60 transmits deposit/withdrawal information to the supplier's collecting system 70 in real-time, whenever money is deposited into/withdrawn from the agent's account.

The functions executed by the supplier's collecting system 70 and the agent terminals 80a to 80b shown in FIG. 3 are basically the same as those executed by the supplier's collecting system 30 and the agent terminals 40a to 40b shown in FIG. 1.

Also, the operation of the financial institution's loan system 50 shown in FIG. 3 is substantially the same as that of the financial institution's loan system 10 shown in FIG. 1, except that the agent's ordinary account and loan account are incorporated into one and the same account. Thus, no further detailed explanation will be given.

The methods according to the above-described embodiments of the present invention can be implemented into a computer-executable program, and can be executed by a general-purpose digital computer which reads from a storage medium with the programs. Usable storage media include magnetic storage media such as ROM, floppy or hard disks, optically readable media such as CD-ROM or DVD, and carrier wave storage media like in Internet-based transmission.

Although the invention has been described and illustrated in detail through preferred embodiments thereof, it will be appreciated by those skilled in the art that numerous other embodiments and modifications may be made without departing from the essential characteristics of the invention. The foregoing description of the present invention is therefore to be considered as illustrative and not restrictive, the scope of the present invention being indicated by the appended claims rather than by the foregoing description, and all changes which come within the meaning and range of equivalency of the claims are therefore intended to be embraced therein.

According to the present invention, multiple agents associated with a supplier can obtain a loan from a financial institution for repayment of supplier's credit sales amount without offering additional collateral to the financial institution, except offering collateral to the supplier. Also, since the multiple agents repay the full amount of credit purchases to the supplier by the appointed date, the supplier can easily conduct application of funds. A financial institution can induce multiple agents associated with the supplier as its clients and guarantee transaction security through supplier's payment guarantee by proxy based on collateral that the agents offer to the supplier.

What is claimed is:

1. A loan system of a financial institution for processing loans for repayment of credit accounts of multiple agents who have purchased products on credit based on collateral offered to a supplier, comprising:
an account opening unit for receiving information required for opening an ordinary account and a loan account of each agent and an ordinary account of the supplier, and opening accounts corresponding the information;
a collateral information receiver unit for receiving information on the appraised value for each agent's collateral offered to the supplier, from a supplier's collecting system;
an ordinary account transfer unit for transferring money from the ordinary account of each agent to the supplier's ordinary account according to money transfer information transferred from agent terminals; and
a loan account transfer unit for transferring loans, each loan processed within the limit of a corresponding agent's collateral only to the supplier's ordinary account according to the loan request information transferred from a corresponding agent terminal.

2. The loan system of a financial institution according to claim 1, further comprising a deposit/withdrawal information transmitter unit for transmitting deposit/withdrawal information to the supplier's collecting system in real-time whenever money is deposited into/withdrawn from an agent's loan account.

3. The loan system of a financial institution according to claim 1, wherein each agent's ordinary account and loan account are one and the same account.

4. The loan system of a financial institution according to claim 1, wherein at least one of the agent terminals is a mobile terminal.

5. A financial institution's loan method for processing loans for repayment of credit accounts of multiple agents who have purchased products on credit based on collateral offered to a supplier, comprising the steps of:
(a) receiving information required for opening an ordinary account and a loan account of each agent and an ordinary account of the supplier, and opening accounts corresponding the information;
(b) receiving information on the appraised value for the agent's collateral offered to the supplier, from a supplier;
(c) transferring money from the ordinary account of each agent to the supplier's ordinary account according to money transfer information from agent terminals; and
(d) transferring loans processed within the limit of a corresponding agent's collateral only to the supplier's ordinary account according to the loan request information transferred from a corresponding agent terminal, if the credit accounts are not fully repaid in step (c).

6. The financial institution's loan method according to claim 5, further comprising the step of (e) transmitting deposit/withdrawal information to the supplier in real-time whenever money is deposited into/withdrawn from an agent's loan account.

7. The financial institution's loan method according to claim 5, wherein in step (a), each agent's ordinary account and loan account are one and the same account.

8. A computer readable recording medium having a financial institution's loan program for processing loans for repayment of credit accounts of multiple agents who have purchased products on credit based on collateral offered to a supplier, the program executing the steps of:
(a) receiving information required for opening an ordinary account and a loan account of each agent and an ordinary account of the supplier, and opening accounts corresponding the information;
(b) receiving information on the appraised value for the agent's collateral offered to the supplier, from a supplier;
(c) transferring money from the ordinary account of each agent to the supplier's ordinary account according to money transfer information from agent terminals; and
(d) transferring loans processed within the limit of a corresponding agent's collateral only to the supplier's ordinary account according to the loan request information transferred from a corresponding agent terminal, if the credit accounts are not fully repaid in step (c).

9. The computer readable recording medium according to claim 8, wherein in step (a), each agent's ordinary account and loan account are one and the same account.
